(19) United States
(12) Patent Application Publication
(10) Pub. No.: US 2026/0229903 A1
(43) Pub. Date: Aug. 6, 2026

(54) STARTING POWER SUPPLY DEVICE CAPABLE OF REVERSE CHARGING

(71) Applicant: Guangdong Aoyun Technology Co., Ltd., Huizhou (CN)

(72) Inventor: Xueping Zhu, Huizhou (CN)

(21) Appl. No.: 19/448,155

(22) Filed: Jan. 14, 2026

Related U.S. Application Data
(63) Continuation-in-part of application No. 19/076,399, filed on Mar. 11, 2025, now Pat. No. 12,528,433.

(30) Foreign Application Priority Data
Jan. 24, 2025 (CN) 202520173854.3
Dec. 22, 2025 (CN) 202522716368.4

(51) Int. Cl. H02J 7/34; H01M 10/42; H01M 10/48; H02J 1/10; H02J 7/00; H02J 7/82; H05B 45/325

(52) U.S. Cl. CPC H02J 7/342; H01M 10/425; H01M 10/488; H02J 1/122; H02J 7/82; H02J 7/855; H05B 45/325

(57) ABSTRACT

A starting power supply device capable of reverse charging includes a main control module, a rechargeable battery connected to the main control module, and a battery level detection module connected to the main control module and the rechargeable battery. The battery level detection module is configured to detect a battery level of the rechargeable battery to generate a battery level signal to be sent to the main control module. The main control module is configured to determine the battery level of the rechargeable battery. The rechargeable battery is connected to a car battery through a control module. Moreover, when the battery level of the rechargeable battery is lower than a preset battery level, the main control module is configured to obtain electrical energy from the car battery to charge the rechargeable battery reversely.

### CROSS-REFERENCE TO RELATED APPLICATIONS

The application is a continuation-in-part of U.S. patent application No. 19/076,399 filed on Mar. 11, 2025, which claims priority of Chinese patent application CN2025201738543, filed on January 24, 2025, and Chinese Patent Application No.CN202522716368.4, filed on December 22, 2025, all contents of which are incorporated herein by reference.

### TECHNICAL FIELD

The present disclosure relates to the technical field of power supplies, particularly to a starting power supply device capable of reverse charging.

### BACKGROUND

A starting power supply device of a car is a multifunctional portable mobile power bank developed for users who travel by driving.

However, during actual use, users have found that traditional starting power supplies have the following problems: when the starting power supplies have insufficient battery level, a special external charging device needs to be used for charging, the charging method is inconvenient, and if it is in the suburbs, charging may even be impossible; after the starting power supplies are used for supporting multiple ignitions, the battery capacity may become insufficient, which can easily lead to deep discharge of the starting power supplies, and the starting power supplies may even be damaged if not charged in time; in low-temperature areas, due to the low temperature, the starting power supplies cannot support multiple ignitions; when not used for a long time, the starting power supplies themselves consume a significant amount of power; the starting power supply cannot be completely disconnected, and the like.

### SUMMARY

In order to overcome the shortcomings of the prior art, a starting power supply device capable of reverse charging is provided in the present disclosure, which uses a car battery to charge a rechargeable battery when a battery level of the rechargeable battery is insufficient, so as to ensure that the battery level of the rechargeable battery is sufficient and protect the rechargeable battery.

A technical solution adopted by the present disclosure to solve its technical problem is as follows.

A starting power supply device capable of reverse charging is provided in the present disclosure, including a main control module, a rechargeable battery connected to the main control module, and a battery level detection module connected to the main control module and the rechargeable battery.

The battery level detection module is configured to detect a battery level of the rechargeable battery to generate a battery level signal, and sending the battery level signal to the main control module.

The main control module is configured to obtain the battery level signal to determine the battery level of the rechargeable battery. Moreover, when the battery level of the rechargeable battery is lower than a preset battery level, the main control module is configured to obtain electrical energy from a car battery to charge the rechargeable battery reversely.

The rechargeable battery is electrically connected to the car battery through a control module.

Beneficial effects of the present disclosure are as follows. By configuring the battery level detection module, the battery level of the rechargeable battery is detected in real time. When the battery level of the rechargeable battery is lower than the preset battery level, the main control module controls the car battery to charge the rechargeable battery, so that the rechargeable battery is charged reversely, thereby ensuring that the battery level of the rechargeable battery is sufficient, effectively protecting the rechargeable battery, and avoiding damage of the battery caused by deep discharge.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a working principle diagram of a starting power supply device according to a first embodiment of the present disclosure.

FIG. 2 is a working circuit diagram of a main control module, a battery level detection module, a temperature detection module, a heating module, and a battery level display module according to the first embodiment of the present disclosure.

FIG. 3 is a working circuit diagram of a rechargeable battery and a control module according to the first embodiment of the present disclosure.

FIG. 4 is a working circuit diagram of a lighting module according to the first embodiment of the present disclosure.

FIG. 5 is a working circuit diagram of a charging module according to the first embodiment of the present disclosure.

FIG. 6 is a working circuit diagram of a battery protection module according to the first embodiment of the present disclosure.

FIG. 7 is a working circuit diagram of a charging interface according to the first embodiment of the present disclosure.

FIG. 8 is a schematic structural diagram of a starting power supply device according to the first embodiment of the present disclosure.

FIG. 9 is a schematic diagram of disassembly of a starting power supply device in one direction according to the first embodiment of the present disclosure.

FIG. 10 is a schematic diagram of disassembly of a starting power supply device in another direction according to the first embodiment of the present disclosure.

FIG. 11 is a schematic structural diagram of an upper housing, a battery level display structure, a positive electrode storage portion, and a negative electrode storage portion of a starting power supply device according to the first embodiment of the present disclosure.

FIG. 12 is a working circuit diagram of a rechargeable battery and a control module according to a second embodiment of the present disclosure.

FIG. 13 is a working circuit diagram of a rechargeable battery and a control module according to a third embodiment of the present disclosure.

FIG. 14 is a working circuit diagram of a rechargeable battery and a control module according to a fourth embodiment of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. In addition, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms "first" and "second" are used for descriptive purposes only and cannot be understood as indicating or implying relative importance or implying the number of indicated technical features. Thus, the features defined as "first" and "second" may explicitly or implicitly include one or more of the features. In the description of embodiments of the application, "a plurality of" means two or more, unless otherwise specifically defined.

### Embodiment I

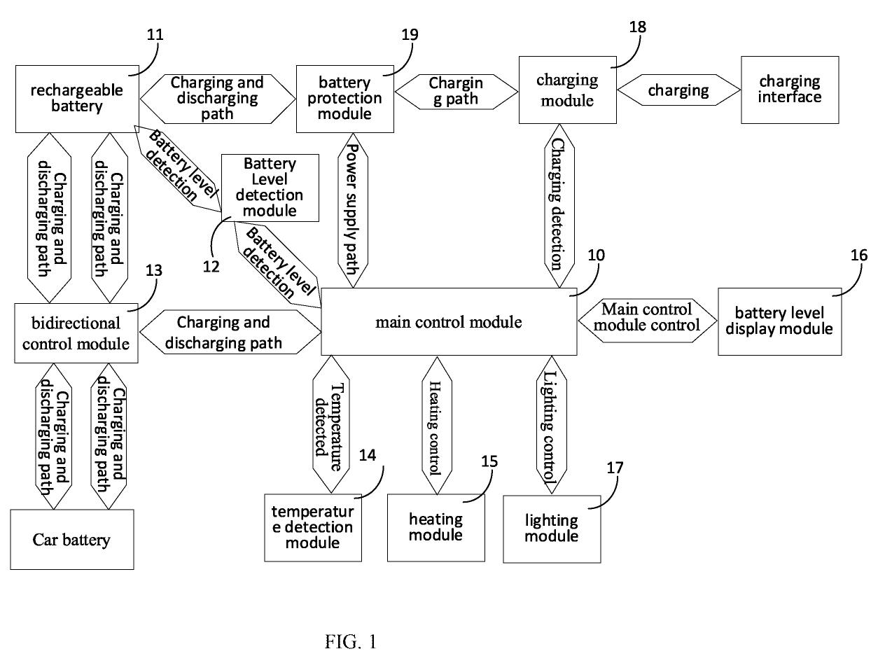

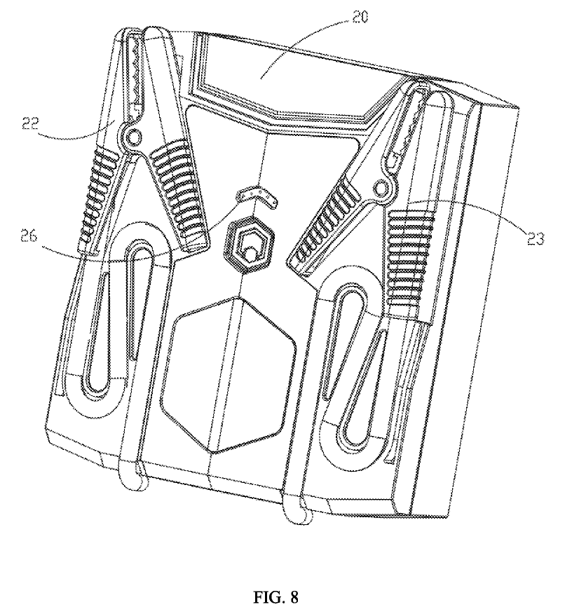

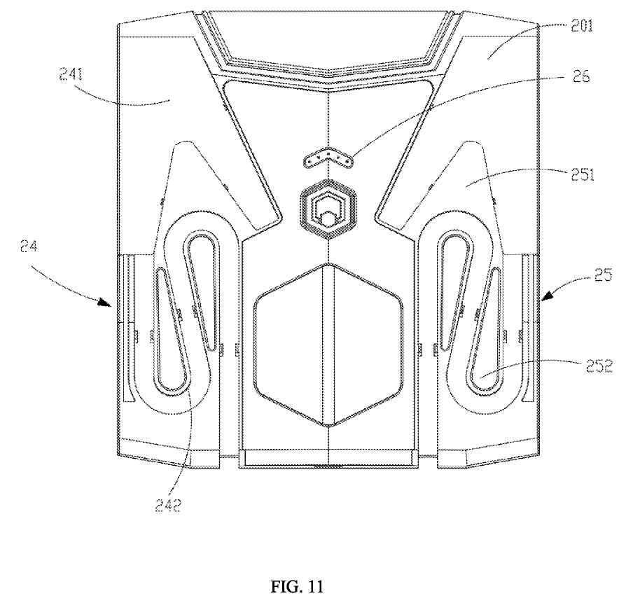

Referring to FIGS. 1-11, a starting power supply device capable of reverse charging provided in a first embodiment includes a main control module 10, a rechargeable battery 11 connected to the main control module 10, and a battery level detection module 12 connected to the main control module 10 and the rechargeable battery 11. The battery level detection module 12 is configured to detect a battery level of the rechargeable battery 11 to generate a battery level signal, and sending the battery level signal to the main control module 10. The main control module 10 is configured to obtain the battery level signal to determine the battery level of the rechargeable battery 11. Moreover, when the battery level of the rechargeable battery 11 is lower than a preset battery level, the main control module 10 is configured to obtain electrical energy from a car battery to charge the rechargeable battery 11 reversely.

In this embodiment, the starting power supply device is an emergency auxiliary power supply when the car battery cannot be started, and is capable of charging the car battery under a control of the main control module 10. By configuring the battery level detection module 12, the battery level of the rechargeable battery 11 is detected in real time. When the battery level of the rechargeable battery 11 is lower than the preset battery level, the main control module 10 controls the car battery to charge the rechargeable battery 11 reversely in a timely manner, so that the battery level of the rechargeable battery 11 is sufficient, the rechargeable battery 11 can be effectively protected, the situation that the rechargeable battery 11 is damaged caused by deep discharge is avoided, and the problem that the rechargeable battery needs to be charged by an external charging device after the existing rechargeable battery 11 supports multiple ignitions is solved. In this embodiment, the rechargeable battery 11 is a lithium battery, and a plurality of lithium batteries are connected to achieve better energy storage and energy supply.

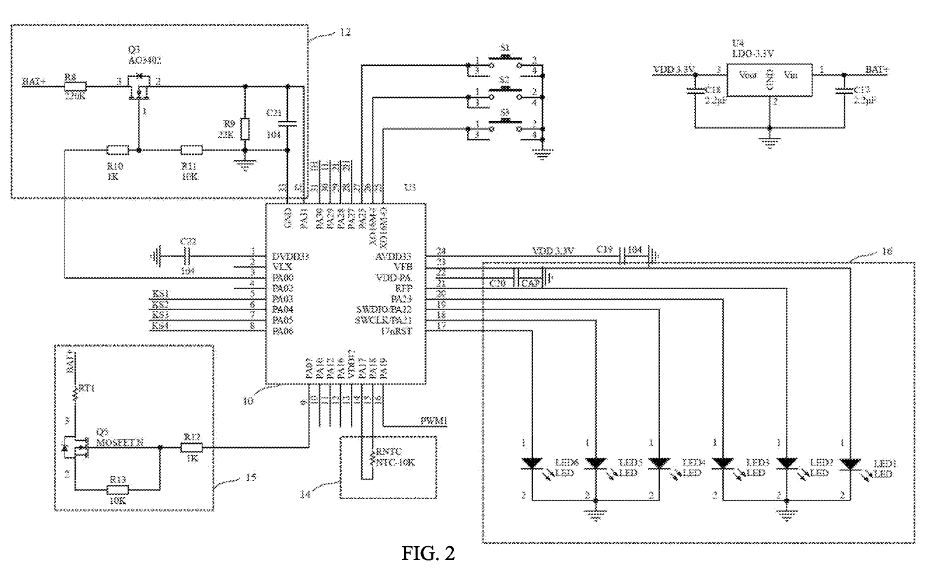

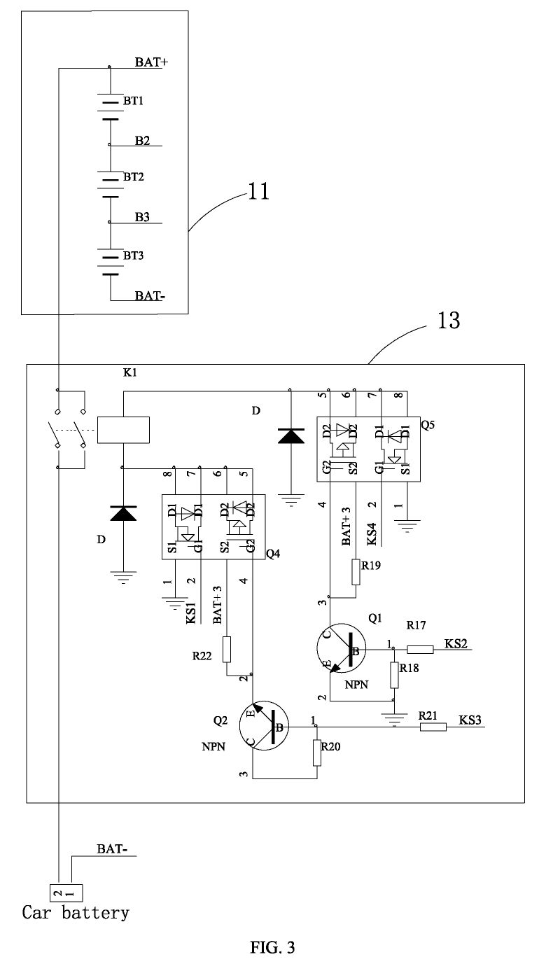

In one embodiment, as shown in FIG. 1 and FIG. 2, the battery level detection module 12 includes a detection triode Q3, a first resistor R8, a second resistor R9, and a first capacitor C21. The main control module 10 outputs a control signal to control the detection triode Q3 to be turned on. A positive electrode of the rechargeable battery 11 is voltage-divided through the first resistor R8 and the second resistor R9. One end of the detection triode Q3 (i.e., a second end of the detection triode Q3 in FIG. 3) is used as a voltage division point, and a voltage of the voltage division point is filtered by the first capacitor C21 and then connected to a detection port of the main control module 10. With the change of a voltage of the rechargeable battery, the voltage of the voltage division point also changes, thereby achieving the detection of the battery level of the rechargeable battery 11. By configuring the first capacitor C21 to filter the voltage of the voltage division point, noise is reduced, and it is ensured that the accuracy of the detected battery level of the rechargeable battery is high.

In one embodiment, as shown in FIGS. 1-3, the rechargeable battery 11 is electrically connected to the car battery through a control module 13. The control module may be a bidirectional control module.

Specifically, the control module 13 includes a magnetic latching relay K1, a forward control circuit connected to the main control module 10 and the magnetic latching relay K1, and a reverse control circuit connected to the main control module and the magnetic latching relay K1. The forward control circuit is configured to receive a forward control signal from the main control module 10, and controlling the magnetic latching relay K1 to be closed based on the forward control signal. The reverse control circuit is configured to receive a reverse control signal from the main control module 10, and controlling the magnetic latching relay K1 to be disconnected based on the reverse control signal. In this embodiment, by configuring the forward control circuit, the magnetic latching relay is controlled to be closed, and by configuring the reverse control circuit, the magnetic latching relay is controlled to be disconnected, so that the problem that the output of the rechargeable battery cannot be completely disconnected is solved. The magnetic latching relay K1 does not need to be continuously powered to maintain a working state, which can significantly reduce the waste of electric energy. Moreover, since a contact state of the magnetic latching relay K1 is maintained by a magnetic force generated by a permanent magnet, the current state can be maintained even after interruption of power supply, without the need for continuous power supply, which can effectively improve stability. In one embodiment, the magnetic latching relay K1 is a bidirectional magnetic latching relay.

Specifically, as shown in FIG. 3, the forward control circuit includes a forward triode Q1, a first forward MOSFET Q5 (G2S2D2), and a second forward MOSFET Q4 (G1S1D1). The forward triode Q1 performs secondary control, so that the main control module 10 controls the first forward MOSFET Q5 (G2S2D2) and the second forward MOSFET Q4 (G1S1D1) to be turned on. The main control module 10 outputs a KS1 effective signal and a KS2 effective signal as the forward control signal to control the magnetic latching relay K1 to be closed.

The reverse control circuit includes a reverse triode Q2, a first reverse MOSFET Q4 (G2S2D2), and a second reverse MOSFET Q5 (G1S1D1). The reverse triode Q2 performs secondary control, so that the main control module 10 controls the first reverse MOSFET Q4 (G2S2D2) and the second reverse MOSFET Q5 (G1S1D1) to be turned on. The main control module 10 outputs a KS3 effective signal and a KS4 effective signal as the reverse control signal to control the magnetic latching relay K1 to be disconnected.

It should be noted that forward and reverse are only used to describe the direction of signal transmission and are not limited. Therefore, the KS1 effective signal and the KS2 effective signal can be used as the reverse control signal, and at this time, the KS3 effective signal and the KS4 effective signal are used as the forward control signal.

In this embodiment, the control module 13 is connected between the car battery and the rechargeable battery 11. After a car is started, the battery level detection module 12 detects a battery level of the rechargeable battery 11 in real time, the control module 13 remains connected, and the main control module 10 obtains electrical energy from the car battery to charge the rechargeable battery 11 reversely when the battery level of the rechargeable battery 11 is lower than the preset battery level.

In this embodiment, after a car is started, even if the power supply is not continued, the control module 13 continuously remains connected. When the battery level of the rechargeable battery 11 is low, the main control module 10 promptly controls the car battery to charge the rechargeable battery 11.

As shown in FIG. 2, the starting power supply device capable of reverse charging further includes a temperature detection module 14 and/or a heating module 15 connected to the main control module 10. The temperature detection module 14 is configured to detect a temperature of the rechargeable battery 11. The heating module 15 is in contact with the rechargeable battery 11. When the temperature of the rechargeable battery 11 is lower than a preset temperature, the main control module 10 starts the heating module 15 to heat the rechargeable battery 11. Specifically, a working circuit diagram of the temperature detection module 14 and the heating module 15 is shown in FIG. 2. The temperature detection module 14 includes an NTC sensor. The NTC sensor is in contact with the rechargeable battery 11 and is configured to accurately detect the temperature of the rechargeable battery 11. The heating module 15 includes a heating sheet in contact with the rechargeable battery 11. In other embodiments, the heating module 15 includes an electric heating wire, an electric heating film, a thermocouple, and the like, which are not limited here. Normally, in a low-temperature environment, due to the low temperature, the rechargeable battery 11 cannot support multiple ignitions, resulting in very low output efficiency. In this embodiment, the temperature of the rechargeable battery 11 is detected in real time, realizing the automatic heating of the rechargeable battery 11 in the low-temperature environment, ensuring the rechargeable battery 11 remains at an appropriate temperature, and achieving a high rate output of the rechargeable battery 11 to start the car, so that in the low-temperature environment, the rechargeable battery 11 can still support multiple ignitions.

Specifically, when the temperature of the rechargeable battery 11 is lower than the preset temperature, the main control module 10 controls the heating module 15 to heat. When the temperature of the rechargeable battery 11 reaches a first heating temperature, the main control module 10 obtains electrical energy from the car battery to charge the rechargeable battery 11 reversely. When the temperature of the rechargeable battery 11 reaches a second heating temperature, the main control module 10 controls the heating module 15 to stop working. By setting the first heating temperature, a guarantee is provided for the high rate output of the rechargeable battery 11, and by setting the second heating temperature, the heating module 15 can automatically stop heating, thereby preventing excessive temperatures from damaging the rechargeable battery 11. It should be noted that the preset temperature, the first heating temperature, and the second heating temperature can be set according to an actual situation, as long as the preset temperature is lower than the first heating temperature and the first heating temperature is lower than the second heating temperature. As an example, the preset temperature is 5 degrees Celsius, the first heating temperature is 12 degrees Celsius, and the second heating temperature is 20 degrees Celsius.

As shown in FIG. 2, the starting power supply device capable of reverse charging further includes a battery level display module 16 connected to the main control module 10. The battery level display module 16 is configured to display the battery level of the rechargeable battery 11. In this embodiment, by configuring the battery level display module 16, a user can intuitively understand a remaining battery level of the rechargeable battery 11. In other ways, the remaining battery level of the rechargeable battery 11 can also be broadcast by setting a sound.

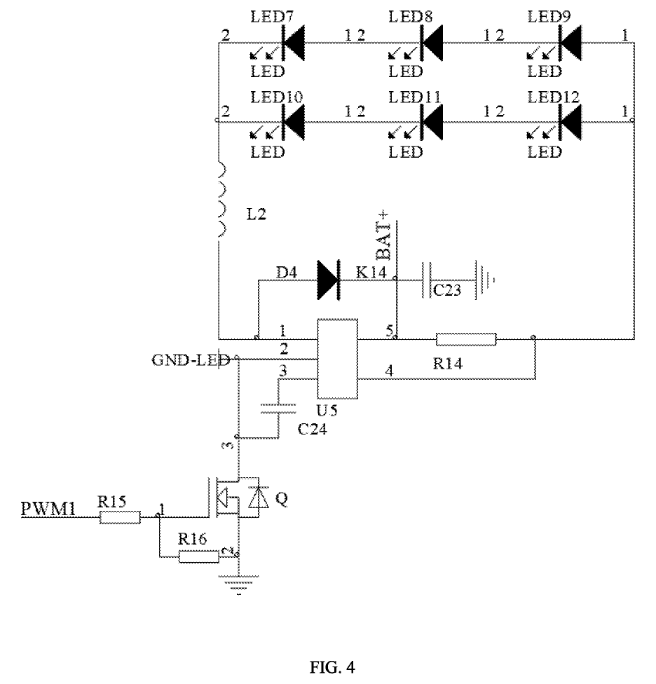

As shown in FIG. 4, the starting power supply device capable of reverse charging further includes a lighting module 17 connected to the main control module 10. The lighting module 17 is configured to emit light. In this embodiment, by configuring the lighting module 17, the user can be provided with convenient lighting outdoors and in places with poor visibility, such as enabling the user to perform an operation of connecting power lines in a clearly lit environment.

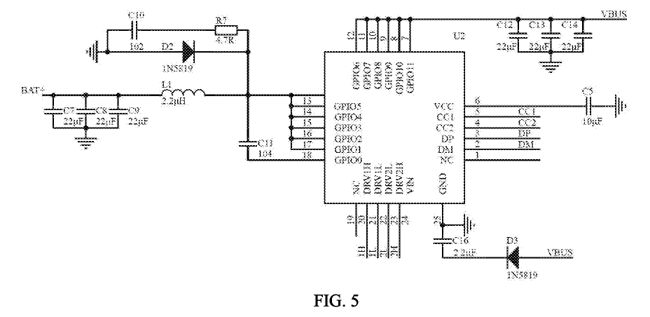

As shown in FIG. 5, the starting power supply device capable of reverse charging further includes a charging module 18 for charging the rechargeable battery 11 reversely. In this embodiment, the charging module 18 is equipped with a USB charging interface. Through the USB charging interface, the rechargeable battery 11 is reversely charged.

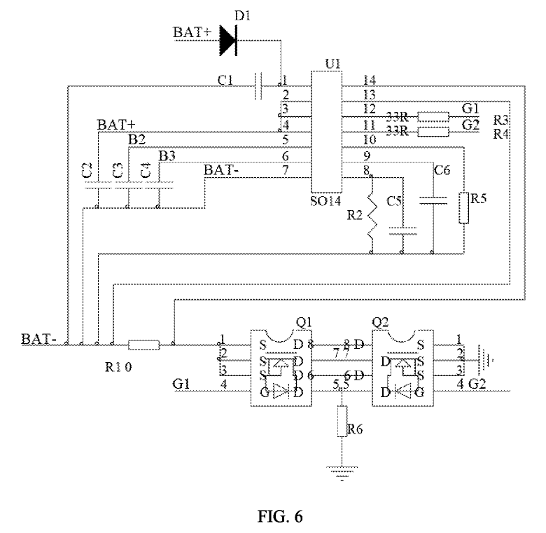

As shown in FIG. 6, the starting power supply device capable of reverse charging is provided with a battery protection module 19 connected between the charging module 18 and the rechargeable battery 11. In this embodiment, the battery protection module 19 is equipped with a current protection function to protect the rechargeable battery 11.

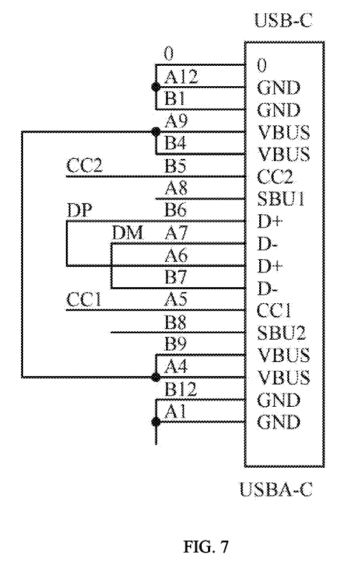

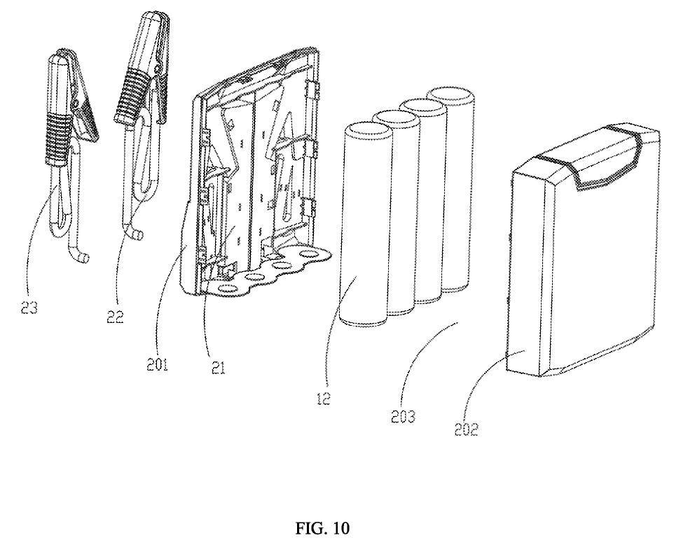

In one embodiment, as shown in FIG. 7 and FIG. 10, the starting power supply device capable of reverse charging further includes a housing 20 and a circuit board 21. An accommodating cavity 203 is formed inside the housing 20 for the installation of the rechargeable battery 11 and the circuit board 21. The main control module 10 is integrated on the circuit board 21. In this embodiment, the main control module 10, the battery level detection module 12, the control module 13, the temperature detection module 14, the heating module 15, the battery level display module 16, the lighting module 17, the charging module 18, and the battery protection module 19 are all integrated on the circuit board 21. In this embodiment, the circuit board 21 is integrated with a main control chip, a lighting chip, a battery protection chip, and a charging chip. The main control module 10, the battery level detection module 12, the control module 13, the temperature detection module 14, the heating module 15, and the battery level display module 16 are all packaged on the main control chip. The lighting module 17 is packaged on the lighting chip, the charging module 18 is packaged on the charging chip, and the battery protection module 19 is packaged on the battery protection chip, so that the efficient operation of each module is ensured. The main control chip adopts a technology of low power consumption, which can maintain longer standby time of a starting battery. Specifically, the power consumption of the main control chip is less than 50 milliwatts.

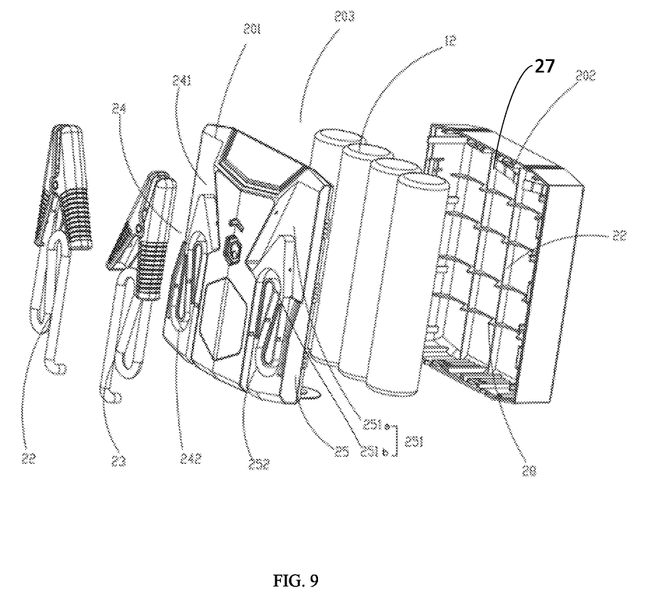

In one embodiment, as shown in FIGS. 9-11, the housing 20 includes an upper housing 201 and a lower housing 202 that are adapted to each other. The accommodating cavity 203 is formed inside the upper housing 201 and the lower housing 202. The housing 20 is equipped with a positive electrode charging clamp 22 and a negative electrode charging clamp 23. A first end of the positive electrode charging clamp 22 is connected to a positive electrode of the rechargeable battery 11, and a second end of the positive electrode charging clamp 22 is used for connecting with the car battery. A first end of the negative electrode charging clamp 23 is connected to a negative electrode of the rechargeable battery 11, and a second end of the negative electrode charging clamp 23 is used for connecting with the car battery.

The housing 20 is provided with a positive electrode storage slot 24 for accommodating the positive electrode charging clamp 22 and a negative electrode storage slot 25 for accommodating the negative electrode charging clamp 23. By configuring the positive electrode storage slot 24 and the negative electrode storage slot 25 to respectively accommodate the positive electrode charging clamp 22 and the negative electrode charging clamp 23, it is ensured that the positive electrode charging clamp 22 and the negative electrode charging clamp 23 are better stored, which can protect the positive electrode charging clamp 22 and the negative electrode charging clamp 23 from damage.

In one embodiment, as shown in FIGS. 9-11, the positive electrode storage slot 24 includes a positive electrode concave groove 241 and a positive electrode wire groove 242 formed on an outer surface of the upper housing 201. The positive electrode concave groove 241 is in communication with the positive electrode wire groove 242 for the placement of the positive electrode charging clamp 22. The negative electrode storage slot 25 includes a negative electrode concave groove 251 and a negative electrode wire groove 252 formed on an outer surface of the upper housing 201. The negative electrode concave groove 251 is in communication with the negative electrode wire groove 252 for the placement of the negative electrode charging clamp 23. In this embodiment, the positive electrode charging clamp 22 includes a positive electrode clamp and a positive electrode connecting wire. The positive electrode clamp is installed in the positive electrode concave groove 241. The positive electrode concave groove 241 is adapted to a shape of the positive electrode clamp. The positive electrode connecting wire is installed in the positive electrode wire groove 242, and the positive electrode wire groove 242 is adapted to a shape of the positive electrode connecting wire, so as to ensure better storage effect and protect the positive electrode charging clamp 22. Similarly, the negative electrode charging clamp 23 includes a negative electrode clamp and a negative electrode connecting wire. The negative electrode clamp is installed in the negative electrode concave groove 251, and the negative electrode concave groove 251 is adapted to a shape of the negative electrode clamp. The negative electrode connecting wire is installed in the negative electrode wire groove 252. The negative electrode wire groove 252 is adapted to a shape of the negative electrode connecting wire, so as to ensure better storage effect and protect the negative electrode charging clamp 23.

The upper housing 201 is equipped with a battery level display structure 26. The battery level display structure 26 includes a plurality of light emitting diodes connected to the main control module 10. The main control module 10 controls one or more of the light emitting diodes to be powered on or off to display the battery level of the rechargeable battery 11. In this embodiment, by configuring the plurality of light emitting diodes, the main control module 10 learns the remaining battery level of the rechargeable battery 11 based on the battery level detection module 12, and controls a light emitting diode corresponding to the remaining battery level to light up, so that the user can intuitively understand the remaining battery level of the rechargeable battery 11. It can be understood that other methods can be configured to display the remaining battery level of the rechargeable battery 11, such as using voice broadcasting to remind the user of the remaining battery level of the rechargeable battery 11, or using an interface to display the remaining battery level of the rechargeable battery 11, which is not limited here.

An inner wall of the lower housing 202 is protruded with a plurality of partition members 27. The plurality of partition members 27 are arranged at intervals to install a plurality of battery cells of the rechargeable battery 11. In this embodiment, by arranging the partition members 27, the plurality of battery cells of the rechargeable battery 11 are separated, so as to better protect the rechargeable batteries 11 and avoid the plurality of rechargeable batteries 11 from being squeezed against each other.

Two adjacent partition members 27 are connected with fixing members 28. The fixing member 28 is arranged in an arc shape in a direction towards the rechargeable battery 11 to adapt to the rechargeable battery 11. Two adjacent partition members 27 are connected with a plurality of fixing members 28, so that the rechargeable battery 11 is stably installed on the fixing members 28 to ensure that the rechargeable battery 11 is stably installed on the housing 20.

A working process of the starting power supply device capable of reverse charging of the present disclosure is as follows: when the car is started, the control module 13 is connected, and the rechargeable battery 11 provides electrical energy to the car. After starting, the control module 13 remains connected continuously, the main control module 10 is configured to output a control signal to control the detection triode Q3 of the battery level detection module 12 to be turned on, the positive pole of the rechargeable battery 11 is voltage-divided through the first resistor R8 and the second resistor R9, one end of the detection triode Q3 serves as a voltage division point, the voltage of the voltage division point is filtered by the first capacitor C2 and then connected to a detection port of the main control module 10, and as the battery voltage changes, the voltage of the voltage division point also changes, thereby achieving battery level detection of the rechargeable battery 11. When the battery level of the rechargeable battery 11 is lower than the preset battery level, the main control module 10 controls the car battery to charge the rechargeable battery 11, thereby achieving reverse charging of the rechargeable battery 11 to effectively protect the rechargeable battery from damage caused by deep discharge. Furthermore, by configuring the temperature detection module 14, the temperature of the rechargeable battery 11 can be detected in real time. When the temperature of the rechargeable battery 11 is lower than the preset temperature, the main control module 10 starts the heating module 15 to heat the battery. When the temperature of the rechargeable battery 11 reaches the first heating temperature, the main control module 10 obtains electrical energy from the car battery to charge the rechargeable battery 11 reversely. When the temperature of the rechargeable battery 11 reaches the second heating temperature, the main control module 10 controls the heating module 15 to stop working. By setting the first heating temperature, the rechargeable battery 11 can be automatically heated, thereby providing a guarantee for the high rate output of the rechargeable battery 11. Furthermore, by configuring the battery level display module 16, the user can intuitively understand the remaining battery level of the rechargeable battery 11. Furthermore, by configuring the lighting module 17, the user can be provided with lighting outdoors or in places with poor visibility, making it convenient for the user to perform other operations.

### Embodiment II

Please refer to FIG. 1, 9, and 12. The main difference between the starting power supply device capable of reverse charging provided in Embodiment 2 of the present application and Embodiment 1 lies in the structure of the control module 13.

In the second embodiment, the control module 13 is configured to be connected between the rechargeable battery 11 and a negative terminal of the car battery. Specifically, two ends of the control module 13 may be respectively connected to the negative terminal BAT- of the rechargeable battery 11 and the negative electrode charging clamp 23. The control module 13 is electrically connected to the main control module 10, and is configured, under a control of the main control module 10, to selectively establish or disconnect an electrical connection between the negative terminal BAT- of the rechargeable battery 11 and the negative electrode charging clamp 23.

The control module 13 includes a transistor Qa and a first control unit 13a connected between a control terminal of the transistor Qa and the main control module 10. Two conducting terminals of the transistor Qa are respectively connected to the negative terminal BAT- of the rechargeable battery 11 and the negative electrode charging clamp 23. The first control unit 13a is configured to control the transistor Qa to be turned on or off under the control of a first control signal KS2 output by the main control module 10, thereby controlling whether the negative terminal BAT- of the rechargeable battery 11 is electrically connected to the negative electrode charging clamp 23.

Specifically, the first control unit 13a includes a first switching transistor Q7 and a second switching transistor Q6. A control terminal of the first switching transistor Q7 is electrically connected to the main control module 10 to receive the first control signal KS2. Two conducting terminals of the first switching transistor Q7 are respectively connected to the ground and electrically connected to a control terminal of the second switching transistor Q6. Two conducting terminals (a first conducting terminals and a second conducting terminals) of the second switching transistor Q6 are respectively electrically connected to the control terminal of the transistor Qa and the positive terminal BAT+ of the rechargeable battery 11.

One of the two conducting terminals of the transistor Qa adjacent to the negative electrode charging clamp 23 is electrically connected to the main control module 10, enabling the main control module 10 to detect a voltage and/or a current of the negative electrode charging clamp 23 (i.e., the voltage and/or the current of the car battery). Based on the voltage and/or current of the car battery, the main control module 10 controls the first control signal KS2, thereby controlling the transistor Qa to be turned on or off.

The transistor Qa is a metal-oxide-semiconductor field-effect transistor (MOSFET), which offers good switching performance, effectively enabling establishment or cutting off of the electrical connection between the car battery and the negative electrode charging clamp 23. In this embodiment, the transistor Qa is an N-MOSFET, and both the first switching transistor Q7 and the second switching transistor Q6 are NPN Bipolar Junction Transistors (BJTs).

The first control unit 13a further includes a first unidirectional diode D1a connected between the positive terminal BAT+ of the rechargeable battery 11 and one of the conducting terminals of the first switching transistor Q7 facing away from the transistor Qa. It is understandable that the first unidirectional diode D1a helps prevent voltage backflow, enhancing safety and stability of the overall circuit.

During operation of the starting power supply device capable of reverse charging, the positive electrode charging clamp 22 and the negative electrode charging clamp 23 of the apparatus are respectively connected to the positive and negative terminals of the car battery. The starting power supply device capable of reverse charging first charges the car battery via the transistor Qa. When the battery level detection module 12 detects the battery level of the rechargeable battery 11 to generate a voltage signal and sends the voltage signal to the main control module 10. The main control module 10 is configured to obtain the voltage signal to determine the battery level of the rechargeable battery 11. When the battery level of the rechargeable battery 11 falls below a preset threshold, the main control module 10 obtains electrical energy from the car battery to reversibly charge the rechargeable battery 11 via the transistor Qa.

It is understandable that during the processes of the starting power supply device charging the car battery via the transistor Qa and the starting power supply device obtaining electrical energy from the car battery to reversibly charge the rechargeable battery 11 via the transistor Qa, the first control signal KS2 is at a low battery level, the first switching transistor Q7 is off, the second switching transistor Q6 is on, and a voltage of the positive terminal of the rechargeable battery 11 controls the transistor Qa to be on.

Furthermore, the main control module 10 can obtain the voltage and/or the current signal KS4 of the negative terminal of the car battery (i.e., the negative terminal of the rechargeable battery 11). Based on the voltage and/or the current signal KS4 from the negative terminal of the car battery, when the rechargeable battery 11 is fully reversely charged (e.g., charged to a preset value), the main control module 10 can control the transistor Qa to turn off, thereby cutting off the electrical connection between the car battery and the negative electrode charging clamp 23. Specifically, the main control module 10 can output a high-level voltage signal as the first control signal KS2 to control the first switching transistor Q7 to turn on. This causes the control terminal of the second switching transistor Q6 to be grounded, the second switching transistor Q6 is thus turned off. Consequently, the transistor Qa can no longer receive a voltage from the positive terminal BAT+ of the rechargeable battery 11 and turns off, thus disconnecting the electrical connection between the car battery and the negative electrode charging clamp 23.

It can be understood that through the configurations of the transistor Qa and the first control unit 13a, the electrical connection between the car battery and the negative electrode charging clamp 23 can be established or cut off. This ensures circuit safety during the charging process and after charging is finished. Moreover, the configurations of the circuit structure not only have a relatively low cost but also have a high switching efficiency, while the stability of the circuit structure is relatively high.

### Embodiment III

Please refer to FIG. 1, 9, and 13. The main difference between the starting power supply device capable of reverse charging provided in the third embodiment of the present disclosure and that in the first embodiment lies in the structure of the control module 13.

In the third embodiment, the control module 13 is configured to be connected between the rechargeable battery 11 and the positive terminal of the car battery. Specifically, two ends of the control module 13 can be respectively connected to the positive terminal BAT+ of the rechargeable battery 11 and the positive electrode charging clamp 22. The control module 13 is electrically connected to the main control module 10 and is configured to selectively establish or disconnect an electrical connection between the positive terminal BAT+ of the rechargeable battery 11 and the positive electrode charging clamp 22 under the control of the main control module 10.

The control module 13 includes a transistor Qb and a second control unit 13b connected between a control terminal of the transistor Qb and the main control module 10. Two conducting terminals of the transistor Qb are respectively connected to the positive terminal BAT+ of the rechargeable battery 11 and the positive electrode charging clamp 22. The second control unit 13b is configured to control the transistor Qb to be turned on or off under control of a second control signal KS3 output by the main control module 10, thereby controlling whether the positive terminal BAT+ of the rechargeable battery 11 is electrically connected to the positive electrode charging clamp 22.

Specifically, the second control unit 13b includes a third switching transistor Q8 and a boost inductor L. A control terminal of the third switching transistor Q8 is electrically connected to the main control module 10 to receive the second control signal KS3. Two conducting terminals of the third switching transistor Q8 are respectively connected to ground and electrically connected to the control terminal of the transistor Qb. The boost inductor L is electrically connected between the control terminal of the transistor Qb and the positive terminal BAT+ of the rechargeable battery 11.

The control terminal of the transistor Qb is electrically connected to the main control module 10, enabling the main control module 10 to detect the voltage and/or the current at the control terminal of the transistor Qb (i.e., the voltage and/or current of the positive terminal BAT+ of the rechargeable battery 11 after voltage boosting by the boost inductor L). Based on the voltage and/or current of the positive terminal BAT+ of the rechargeable battery 11, the main control module 10 controls the second control signal KS3, thereby controlling the transistor Qb to be turned on or off.

Specifically, the control terminal of the transistor Qb may be grounded via a voltage divider circuit 13c, and a voltage division node of the voltage divider circuit 13c is connected to the main control module 10.

The transistor Qb is a metal-oxide-semiconductor field-effect transistor (MOSFET), which has good switching performance and can effectively establish or cut off the electrical connection between the car battery and the positive electrode charging clamp 22. In this embodiment, the transistor Qb is an N-MOSFET, and the third switching transistor Q8 is an NPN bipolar junction transistor (BJT).

The second control unit 13b further includes a second unidirectional diode D1b connected between the boost inductor L and the control terminal of the transistor Qb.

During operation of the starting power supply device capable of reverse charging, the positive electrode charging clamp 22 and the negative electrode charging clamp 23 of the starting power supply device are respectively connected to the positive and negative terminals of the car battery. The starting power supply device capable of reverse charging first charges the car battery via the transistor Qb. When the battery level detection module 12 detects the battery level of the rechargeable battery 11 to generate a voltage signal and sends the voltage signal to the main control module 10, the main control module 10 obtains the voltage signal to determine the battery level of the rechargeable battery 11. When the battery level of the rechargeable battery 11 falls below a preset threshold, the main control module 10 obtains electrical energy from the car battery to reversibly charge the rechargeable battery 11 via the transistor Qb.

It can be understood that during the processes of the starting power supply device charging the car battery via the transistor Qb and the starting power supply device obtaining electrical energy from the car battery to reversibly charge the rechargeable battery 11 via the transistor Qb, the second control signal KS3 is at a low battery level, the third switching transistor Q8 is off, and the positive terminal voltage BAT+ of the rechargeable battery 11, after being boosted by the boost inductor L (and associated circuitry), controls the transistor Qb to be on.

Furthermore, the main control module 10 can obtain the voltage and/or current of the positive terminal of the car battery (i.e., the positive terminal of the rechargeable battery 11). Based on the voltage and/or the current signal KS1, when the rechargeable battery 11 is fully reversely charged (e.g., charged to a preset value), the main control module 10 can control the transistor Qb to turn off, thereby cutting off the electrical connection between the car battery and the positive electrode charging clamp 22. Specifically, the main control module 10 can output a high-level voltage signal KS3 as the second control signal KS3 to control the third switching transistor Q8 to be turned on. This causes the control terminal of the transistor Qb to be grounded, the transistor Qb is thus turned off. Consequently, the transistor Qb can no longer receive a voltage from the positive terminal BAT+ of the rechargeable battery 11 and turns off, thus disconnecting the electrical connection between the car battery and the positive electrode charging clamp 22.

It can be understood that through the configuration of the transistor Qb and second control unit 13b, the electrical connection between the car battery and the positive electrode charging clamp 22 can be established or cut off. This ensures circuit safety during the charging process and after charging is finished. Moreover, the configurations of the aforementioned circuit structure not only have a relatively low cost but also have a high switching efficiency, while the stability of the circuit structure is relatively high.

### Embodiment IV

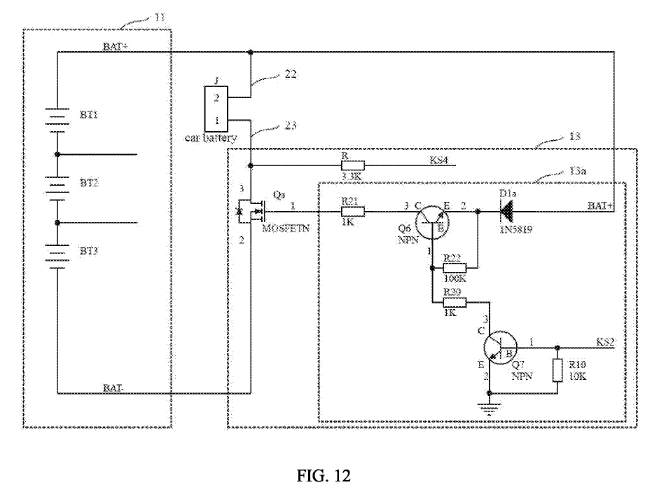

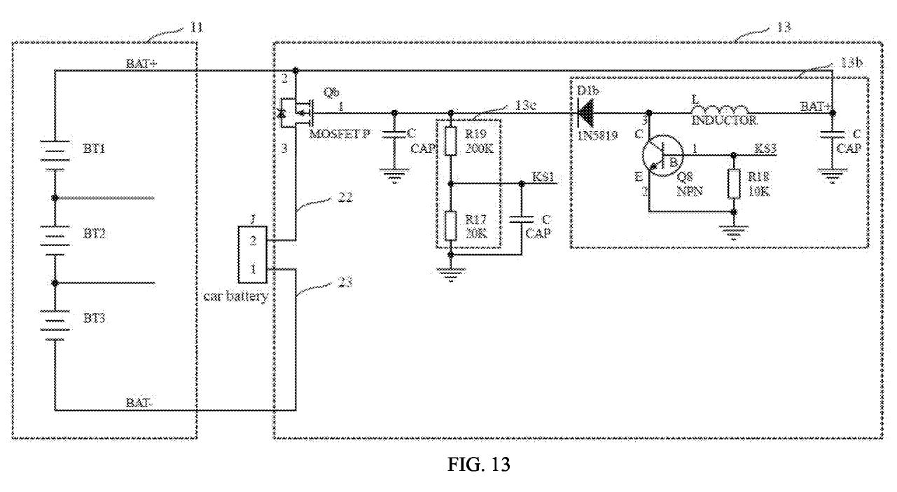

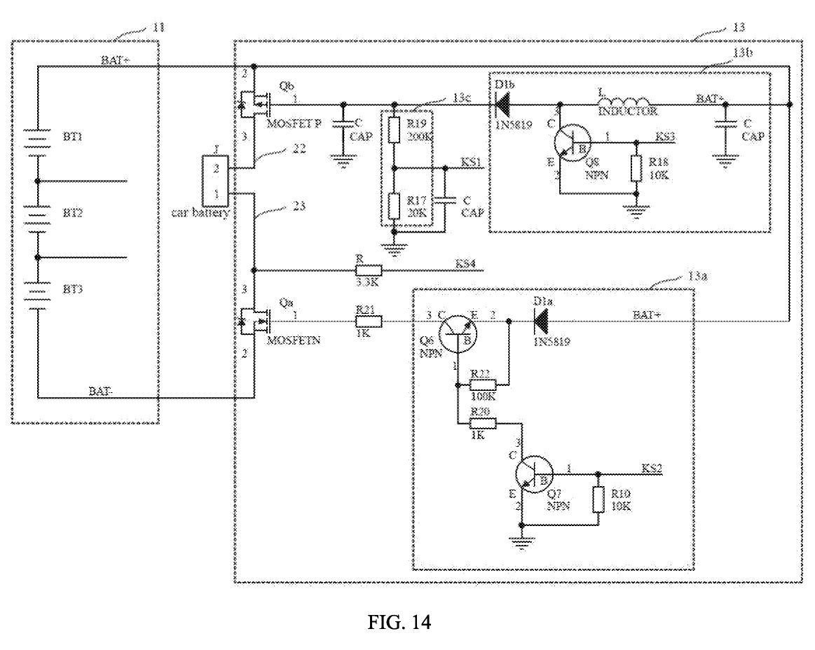

Please refer to FIGS. 1, 9, 12, 13, and 14, the main difference between the starting power supply device capable of reverse charging provided in the fourth embodiment of the present disclosure and the first embodiment lies in the structure of the control module 13.

Specifically, the control module 13 includes a transistor Qa, a first control unit 13a connected between the control terminal of the transistor Qa and the main control module 10, a transistor Qb, and a second control unit 13b connected between the control terminal of the transistor Qb and the main control module 10.

The structure and working principles of the transistor Qa and the first control unit 13a are the same as those of the transistor Qa and the first control unit 13a in the second embodiment and will not be described again here.

The structure and working principles of the transistor Qb and the second control unit 13b are the same as those of the transistor Qb and the second control unit 13b in the third embodiment and will not be described again here.

Furthermore, the transistor Qa and the transistor Qb can be turned on or off simultaneously, and the first control unit 13a and the second control unit 13b can operate simultaneously.

It can be understood that in the fourth embodiment, by configuring the transistor Qa, the first control unit 13a, the transistor Qb, and the second control unit 13b, the connection or disconnection between the positive and negative terminals of the rechargeable battery 11 and the positive and negative terminals of the car battery can be controlled respectively. This can further ensure stability of the overall circuit operation.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A starting power supply device capable of reverse charging, comprising:
a main control module;
a rechargeable battery connected to the main control module; and
a battery level detection module connected to the main control module and the rechargeable battery;
wherein the battery level detection module is configured to detect a battery level of the rechargeable battery to generate a battery level signal, and sending the battery level signal to the main control module;
the main control module is configured to obtain the battery level signal to determine the battery level of the rechargeable battery, and when the battery level of the rechargeable battery is lower than a preset battery level, to obtain electrical energy from a car battery to charge the rechargeable battery reversely; and
the rechargeable battery is electrically connected to the car battery through a control module.

2. The starting power supply device capable of reverse charging according to claim 1, wherein
the control module comprises a bidirectional magnetic latching relay, a forward control circuit connected to the main control module and the bidirectional magnetic latching relay, and a reverse control circuit connected to the main control module and the bidirectional magnetic latching relay;
the forward control circuit is configured to receive a forward control signal from the main control module, and to control the bidirectional magnetic latching relay to be closed based on the forward control signal;
the reverse control circuit is configured to receive a reverse control signal from the main control module, and to control the bidirectional magnetic latching relay to be disconnected based on the reverse control signal.

3. The starting power supply device capable of reverse charging according to claim 1, wherein the control module comprises a first transistor and a first control unit connected between a control terminal of the first transistor and the main control module; two conducting terminals of the first transistor is respectively connected to a negative terminal of the rechargeable battery and a negative electrode charging clamp of the starting power supply device; and the first control unit is configured to selectively establish or disconnect an electrical connection between the negative terminal of the rechargeable battery and the negative electrode charging clamp under a control of the main control module.

4. The starting power supply device capable of reverse charging according to claim 3, wherein the first transistor is an MOSFET, the first control unit comprises a first switching transistor and a second switching transistor; a control terminal of the first switching transistor is electrically connected to the main control module and is configured to receive the first control signal, two conducting terminals of the first switching transistor are respectively grounded and electrically connected to a control terminal of the second switching transistor; and two conducting terminals of the second switching transistor are respectively connected to the control terminal of the first transistor and a positive terminal of the rechargeable battery.

5. The starting power supply device capable of reverse charging according to claim 4, wherein first transistor is an N-MOSFET, both the first switching transistor and the second switching transistor are NPN bipolar junction transistor.

6. The starting power supply device capable of reverse charging according to claim 4, wherein the first control unit further comprises a first unidirectional diode connected between the positive terminal of the rechargeable battery and one of the conducting terminals of the first switching transistor facing away from the transistor.

7. The starting power supply device capable of reverse charging according to claim 1, wherein the control module comprises a second transistor and a second control unit connected between a control terminal of the second transistor and the main control module; the second transistor is an MOSFET, two conducting terminals of the second transistor are respectively connected to a positive terminal of the rechargeable battery and a positive electrode charging clamp; the second control unit is configured to control the second transistor to be turned on or off under control of a second control signal outputted by the main control module, thereby controlling whether the positive terminal of the rechargeable battery is electrically connected to the positive electrode charging clamp.

8. The starting power supply device capable of reverse charging according to claim 7, wherein the second control unit comprises a third switching transistor and boost inductor; a control terminal of the third switching transistor is electrically connected to the main control module and is configured to receive the second control signal; two conducting terminals of the third switching transistor are respectively grounded and electrically connected to the control terminal of the second transistor; and the boost inductor is connected between the control terminal of the second transistor and the positive terminal of the rechargeable battery.

9. The starting power supply device capable of reverse charging according to claim 8, wherein the control terminal of the second transistor is further connected to the main control module to allow the main control module to detect a voltage and/or a current at the positive terminal of the rechargeable battery after voltage boosting by the boost inductor; the main control module is configured to output the second control signal based on detected voltage and/or current to control the second transistor to be turned on or off.

10. The starting power supply device capable of reverse charging according to claim 7, wherein the second transistor is grounded via a voltage divider circuit, and a voltage division node of the voltage divider circuit is connected to the main control module.

11. The starting power supply device capable of reverse charging according to claim 8, wherein the second transistor is an N-MOSFET, and the third switching transistor is a NPN bipolar junction transistor.

12. The starting power supply device capable of reverse charging according to claim 8, wherein the second control unit further comprises a second unidirectional diode connected between the boost inductor L and the control terminal of the transistor.

13. The starting power supply device capable of reverse charging according to claim 1, wherein after a car is started, the battery level detection module detects a battery level of the rechargeable battery in real time, the control module remains connected, and the main control module is configured to control the control module to start the car battery to reversely charge the rechargeable battery when the battery level of the rechargeable battery is lower than a preset battery level.

14. The starting power supply device capable of reverse charging according to claim 1, wherein the battery level detection module comprises a detection triode, a first resistor, and a second resistor; the main control module is used for outputting a control signal to control the detection triode to be turned on; after the detection triode is turned on, a positive electrode of the rechargeable battery is voltage-divided through the first resistor and the second resistor, and a voltage at one end of the detection triode is connected to a detection port of the main control module.

15. The starting power supply device capable of reverse charging according to claim 1, further comprising a battery level display module connected to the main control module and a charging module for charging the rechargeable battery; wherein the battery level display module is used for displaying the battery level of the rechargeable battery, and a battery protection module is connected between the charging module and the rechargeable battery.

16. The starting power supply device capable of reverse charging according to claim 1, further comprising a housing and a circuit board, wherein an accommodating cavity is formed inside the housing for the installation of the rechargeable battery and the circuit board, and the main control module is integrated on the circuit board.

17. The starting power supply device capable of reverse charging according to claim 16, wherein the housing comprises an upper housing and a lower housing, and the accommodating cavity is formed inside the upper housing and the lower housing; the housing is equipped with a positive electrode charging clamp and a negative electrode charging clamp; a first end of the positive electrode charging clamp is connected to a positive electrode of the rechargeable battery, and a second end of the positive electrode charging clamp is used for connecting with a car battery; a first end of the negative electrode charging clamp is connected to a negative electrode of the rechargeable battery, and a second end of the negative electrode charging clamp is used for connecting with the car battery.

18. The starting power supply device capable of reverse charging according to claim 16, wherein the upper housing is equipped with a battery level display structure, the battery level display structure comprises a plurality of light emitting diodes connected to the main control module, and the main control module controls one or more of the plurality of light emitting diodes to be powered on or off to display a battery level of the rechargeable battery; an inner wall of the lower housing is protruded with a plurality of partition members, and the plurality of partition members are arranged at intervals to install a plurality of battery cell of the rechargeable battery; two adjacent partition members are connected to at least one fixing member, and a side of the at least one fixing member facing the rechargeable battery is arc-shaped to fit a shape of the rechargeable battery.

19. The starting power supply device capable of reverse charging according to claim 16, wherein an outer surface of the housing is provided with a positive electrode storage slot configured to accommodate the positive electrode charging clamp and a negative electrode storage slot configured to accommodate the negative electrode charging clamp.

20. The starting power supply device capable of reverse charging according to claim 19, wherein the positive electrode storage slot comprises a first portion configured to accommodate the positive electrode charging clamp and a second portion configured to accommodate cables connected to the positive electrode charging clamp; the negative electrode storage slot comprises a third portion configured to accommodate the negative electrode charging clamp and a fourth portion configured to accommodate cables connected to the negative electrode charging clamp; the positive electrode storage slot is arranged opposite to the negative electrode storage slot; and the cables connected to the positive electrode charging clamp and the cables connected to the negative electrode charging clamp extend into the housing to be electrically connected to the circuit board.
